(19) United States
(12) Patent Application Publication
(10) Pub. No.: US 2006/0077875 A1
(43) Pub. Date: Apr. 13, 2006

(54) Optical recording medium

(75) Inventors: Noriko Inoue, Kanagawa (JP); Hiroaki Takano, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/213,752

(22) Filed: Aug. 30, 2005

(30) Foreign Application Priority Data
Sep. 14, 2004 (JP) 2004-267093

(51) Int. Cl. G11B 7/24

(52) U.S. Cl. 369/275.1

(57) ABSTRACT

An optical recording medium includes a body, optical information recording layer, and a cartridge. The body includes two light transmissive substrates each including a thickness not less than 50 μm; and an optical information recording layer including a thickness not less than 100 μm in thickness between said two light transmissive substrates, the optical information recording layer comprising an optical recording material, wherein information is recorded in physical change of the optical recording material by recording light; and a cartridge for enclosing the body comprising a light-shielding material including a transmittance of not greater than one percent at range of ultraviolet and visible light.

### BACKGROUND OF THE INVENTION

1. Field of the Invention

The present invention relates to an optical recording medium, particularly, to the optical recording medium for a three-dimensional recording such as a multilayer optical memory and a hologram memory, and particularly to an optical recording medium which is relatively thick.

2. Description of the Related Art

As optical recording media that are now or will be imminently put to practical use are known various optical recording media such as a CD-R, a DVD (Digital Versatile Disk), and a Blu-ray disk. However, recording capacities of these optical recording media are around 27 GB at maximum, and is requested a development of a higher recording capacity of an optical recording medium in order to handle a large amount of data accompanied with a progress of a highly-networked information society in these years. Consequently, as the higher recording capacity of the optical recording medium is noticed such ones utilizing a holographic memory, a multilayer optical memory, and proximity field light, and a development thereof is being proceeded as next-generation optical recording media.

The conventional optical recording medium such as the CD-R, the DVD, and the Blu-ray disk records information in so-called heat mode in which the information is recorded by generating phase transition, magnetizing reaction or thermal deformation. On the other hand, the next-generation optical recording medium such as the holographic memory records the information in a so-called photon mode in which chemical reaction of the recording medium by optical energy. The optical recording by the photon mode is considered to be capable of high speed and high density recording. However, the optical recording in the photon mode requires use of extremely light-sensitive recoding material as photographic films do. Accordingly, until information has been recorded, it is important to provide light-shielding property to the optical recording medium.

Japanese laid-open patent application publication No. 2004-29476 discloses (in claims 4 and 5) that a recording medium is enclosed in a light-shield cartridge to improve a light-shielding property of a hologram recording medium having a structure in which a holographic recording layer made of an optical cured organic material is sandwiched between two holding substrates. However, the optical recording medium utilizing an optical recording material of the photon mode with a high sensitivity requires a further high optical shielding property to prevent stable information recording from being difficult because the optical recording material senses unexpected leaked light until information is recorded on the optical recording medium by radiating a recording light. Particularly, in a disk medium, a hub for rotating the disk medium for recording and reproducing is provided at the center portion of the disk, which may cause light to leak at the peripheral portion of the hub of the cartridge. To prevent such light leaking, improvement in the light-shielding property of the recording medium is requested.

### SUMMARY OF THE INVENTION

An aspect of the present invention provides an optical recording medium in which a light-shielding property until information is recorded is improved to provide stable optical recording.

Another aspect of the present invention provides an optical recording medium comprising: a body comprising: two light transmissive substrates each including a thickness not less than 50 μm; and an optical information recording layer including a thickness not less than 100 μm between the two light transmissive substrates, the optical information recording layer comprising an optical recording material, wherein information is recorded in physical change of the optical recording material by recording light; and a cartridge comprising a light-shielding material including a transmittance of not greater than one percent at a range over ultraviolet and visible light for enclosing the body.

### BRIEF DESCRIPTION OF THE DRAWINGS

The object and features of the present invention will become more readily apparent from the following detailed description taken in conjunction with the accompanying drawings in which:

FIG. 1 is a perspective view showing an optical recording medium according to the present invention;

FIG. 2 is a schematic section drawing showing a structure of the optical recording medium shown in FIG. 1;

FIG. 3 is a perspective view showing the optical recording medium according to the present invention;

FIG. 4 is a schematic section drawing showing a structure of the optical recording medium shown in FIG. 3;

FIG. 5 is a schematic drawing for illustrating a measurement method of a diffraction efficiency;

FIG. 6 is a schematic section drawing showing another example of the optical recording medium shown in FIG. 3;

FIG. 7 is a schematic section drawing showing still another example of the optical recording medium shown in FIG. 3; and

FIG. 8 is a schematic sectional view showing a light-shield cartridge with light-shield package member according to the present invention.

The same or corresponding elements or parts are designated with like references throughout the drawings.

### DETAILED DESCRIPTION OF THE INVENTION

Hereinafter will be described an embodiment according to the present invention with reference to drawings.

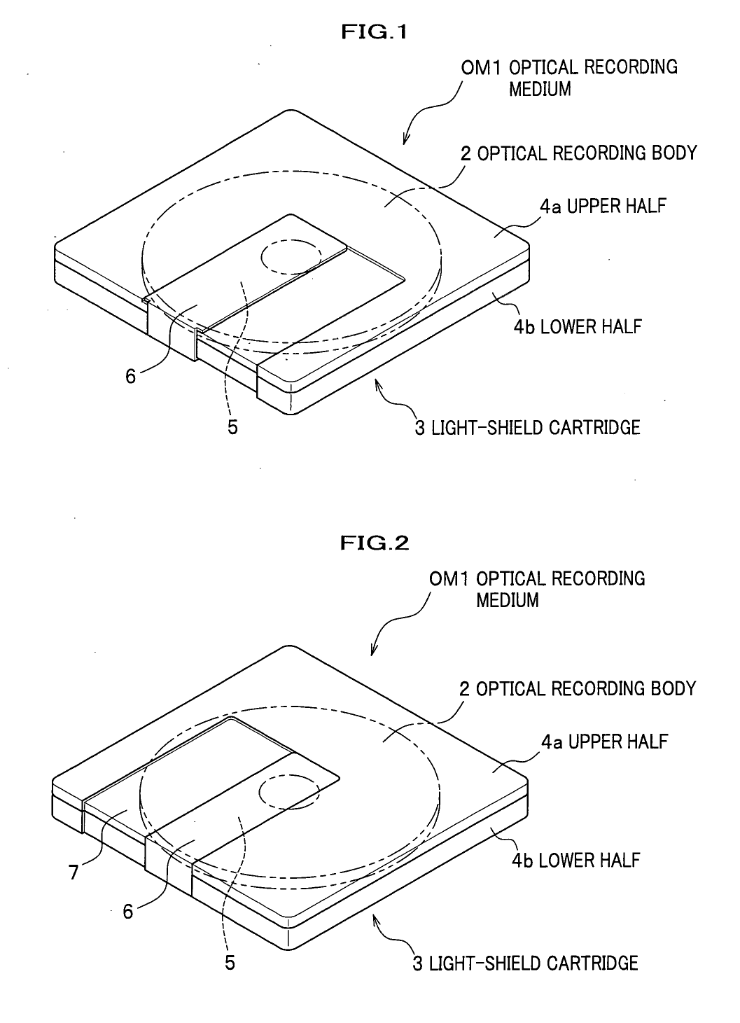

FIG. 1 shows an upper side of an optical recording medium OM1 for holographic recording. FIG. 2 shows a lower side of the optical recording medium OM1.

The optical recording medium OM1 comprises, as shown in FIG. 1, an optical recording body 2 and a light-shield cartridge 3 for enclosing the optical recording body 2.

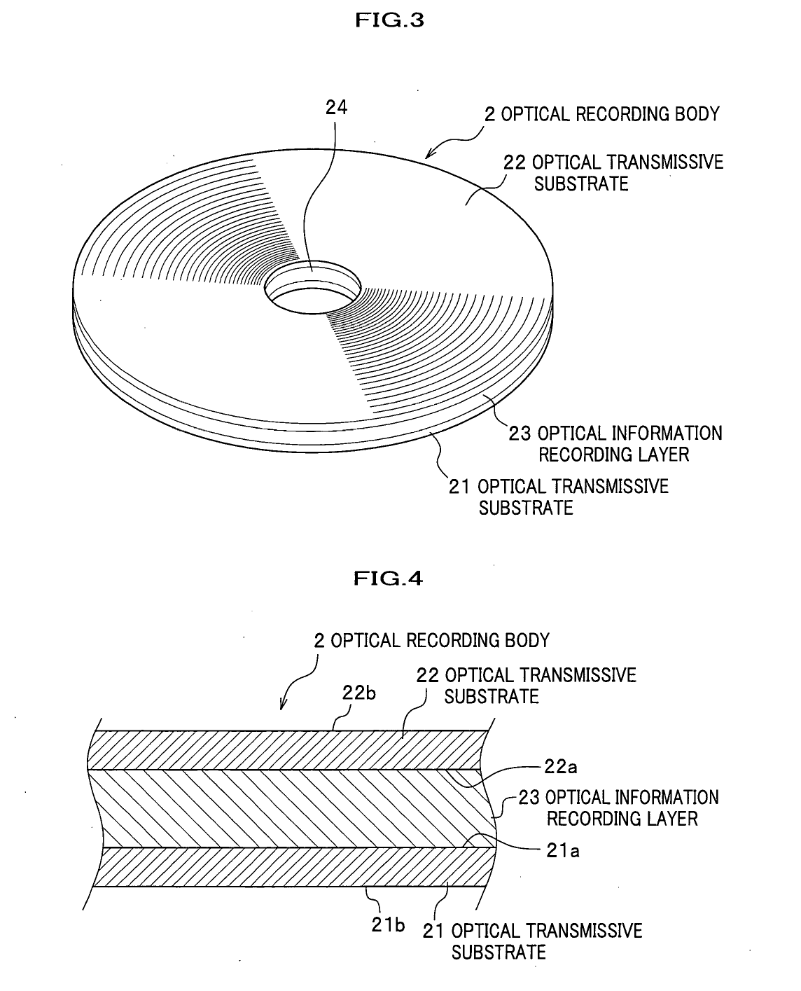

The optical recording medium OM1 shown in FIG. 1 comprises light transmissive substrates 21 and 22, and an optical information recording layer 23 provided between the light transmissive substrates 21 and 22 as shown in the perspective view in FIG. 3 and a schematic section drawing shown in FIG. 4, and thus composed of a disk-form lamination body where a fitting hole 24 for a drive mechanism (not shown) for rotating the optical recording medium OM1 in recording and reproducing by hologram is drilled at center thereof.

The light transmissive substrates 21 and 22 are not specifically limited and composed of any of a film and sheet of a natural or synthetic organic resin: for example, an inorganic substance such as glass and organic synthetic resins such as a polycarbonate (hereinafter abbreviated as “PC”), triacetylcellulose (hereinafter abbreviated as “TAC”), cycloolefin polymer, polyethylene terephthalate (hereinafter abbreviated as “PET”), polyphenylene sulfide (hereinafter abbreviated as “PPS”, acrylic resin, methacrylic resin, polystyrene resin, vinyl chloride resin, epoxy resin, polyester resin, and amorphous polyolefin. Specifically, glass, PC, TAC, and the like are preferable because of a lower double refractivity. The light transmissive substrates 21 and 22 may be formed of a same material, and of different materials.

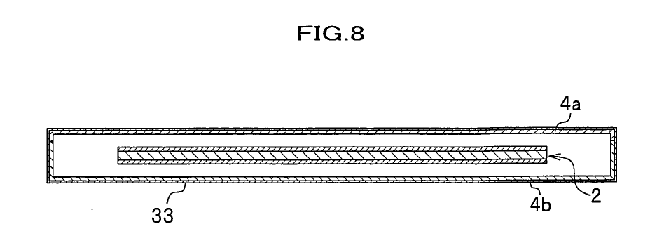

In the light transmissive substrate 21 a reflection layer 32 (see FIG. 7) may be provided on a surface 21a (see FIG. 4) contacting the optical information recording layer 23, and it is preferable that the reflection layer is formed by sputtering elements such as Au, Ag, Al, Pt, Cu, Ni, Si, Ge, Cr, and the like independently or in combination.

In addition, the light transmissive substrates 21 and 22 are comparatively thick, not less than 50 μm in thickness from a view point of rigidity in handling, and preferably around 50 to 1500 μm in thickness.

The two light transmissive substrates 21 and 22 are preferably formed with materials having no absorption at wavelength ranges of recording light for recording information on the optical information recording layer 23, reading light (servo light) for reproducing servo control information (data) recorded on the optical recording medium OM1, and fixing light (fixer) used for fixing the physical change in the optical recording material. This provides recording and fixing of information without influence of heat. More specifically, the two light transmissive substrates 21 and 22 transmit the recording light, reading light for reading servo control information to be recorded in the optical information recording layer and fixing light for fixing the optical recording material.

As the materials having no absorption (transmission) at a wavelength region of recording light for recording information on the optical information recording layer 23, are used materials capable of being used for the light transmissive substrates 21 and 22 without absorption at a wavelength region of the recording light, the servo light, and the fixing light.

Furthermore, on the surface 21a of the light transmissive substrate 21 contacting the optical information recording layer 23, it is available in advance to form a convex and concave pre-format pattern indicating information for performing servo control such as a tracking servo and a focus servo, and information for identifying an address of the optical information recording layer 23; and a servo signal recording area consisting of pits. Thus in a hologram memory it is accurately performed to form an interference pattern by interference of reference light and information light in the optical information recording layer 23, and it is enabled to accurately record optical information. In addition, in reproducing it is enabled to accurately reproduce optical information by reference light. The information recorded in the servo signal recording area is reproduced, using a laser not less than 600 nm not absorbed by an optical recording material composing the optical information recording layer 23. In addition, a protective layer for blocking oxygen may also be provided on the optical information recording layer 23.

As concrete examples of the optical recording material can be used a silver halide, a gelatin bichromate, a photorefractive material, a photochromic material, a photopolymer material, and the like. Out of these, the photopolymer material has advantages of being able to obtain a high diffraction efficiency, being lower in noise, and being better in storage stability if completely fixed after recording; and therefore, a research and development thereof is made to proceed. The photopolymer material usually contains a binder, a polymerizing monomer, a sensitizing dye, a polymerization initiator, and the like. It is desirable to use the binder and polymerizing monomer having a different refractivity. If in recording optical information an interference pattern is formed within the optical information recording layer 3 of the optical recording medium OM1, the sensitizing dye is excited at a light portion of the interference pattern and emits electrons. The emitted electrons move to the polymerization initiator and generate radicals; and the radicals move to the polymerizing monomer, and thereby the polymerization is initiated. Some polymerizing monomers cause the polymerization by an acid generation agent. As the result, the photopolymer material becomes a configuration of the polymerizing monomer being rich at the light portion of the interference pattern and the binder being rich at the shade portion of the interference pattern, and a refractivity difference is recorded within the optical recording medium as an interference pattern. A polymerizing monomer not used for recording optical information is uniformly exposed to be fixed, using a laser and a white-light source after recording. In addition, depending on a material, some polymerizing monomers are fixed with a heat treatment.

The binder is preferably higher in transmittance and lower in double refraction. As concrete examples of the binder can be cited chlorinated polyethylene, polymethylmethacrylate, a copolymer of methylmethacrylate and (meta)acrylate alkylester other than methylmethacrylate, a copolymer of vinyl chloride and acrylonitrile, polyvinyl acetate, polyvinyl alcohol, polyvinyl methylal, polyvinyl butyral, polyvinyl pyrrolidone, ethylcellulose, accetylcellulose, and polycarbonate.

In a case of the photopolymer material, because recording is performed by a difference between refractivities of a binder and a polymerizing monomer, the monomer having a refractivity adequate for the recording is used. A copolymer is not specifically limited if it has a polymerization group. For example, a radical polymerizing monomer or a cation polymerizing monomer or both polymerizing monomers may be simultaneously used, and to be more precise, compounds containing a polymerization group such as an epoxy group and an ethylene unsaturated group can be used. A polymerizing monomer containing one or more of these polymerization groups in a molecule is used, and when containing two or more of these polymerization groups in the molecule, they may be different or same.

As the sensitizing dye is used one having an absorption peak in a wavelength of recording light, and a light absorption efficiency ε of the dye itself is preferably low in the wavelength of the recording light. As the sensitizing dye can be used known organic dyes such as a cyan, merocyan, phthalocyan, azo, azomethine, indoaniline, xanthene, coumarin, polymethine, diarylethene, fulgide, fluorane, anthraquinone, and styryl.

Furthermore, the polymerization initiator is not specifically limited if it is thermally inactive at not more than 80 degrees Celsius and generates a proper free radical. In addition, in a case of using a polymerizing monomer of a cation polymerization, it is preferable to use an acid generation agent.

In addition, even substances other than the above can be used as the optical recording material if physicality of their raw material changes along light and shade of an interference pattern and such a refractivity difference and a transmission difference occur therein. In addition, combinations of these, for example, a dye colored or decolored by light radiation and a constituent containing a photopolymer, a photorefractive material and the constituent containing the photopolymer, and the like can be used as a hologram recording material.

In the optical information recording layer 23, information is recorded by change in structure of the optical recording material caused by the recording light. The optical information recording layer 23 is made of, for example, any material of which optical characteristics such as refractive index, transmittance, permittivity, reflectivity, absorption index change along highlight and shadow in an interference pattern formed in the optical information recording layer 23 when the recording light is radiated.

Among materials for the optical information recording layer 23 that can record the information by the structural change (physical change) in the optical recording material in response to the recording light, for example, are available a material of a mixture including, in the optical information recording layer, a binder, sensitizing dye, an acid (base) generation agent, dye causing refractive index demodulation due to structural change by generation of the acid (base), a substance developing refractive index modulation due to structural change in the sensitizing dye, a photochromic, and a photorefractive material. As the sensitizing dye, the component used in the optical recording material is available. As the dye showing the refractive index modulation is available dye of which structure is changed by acid/base without absorption at a wavelength region of the recording light. As the acid generation agent are available, for example, diallyl iodoniumu salts, sulfonate, and sulfonic ester.

The optical recording material may appropriately contain something regularly used for forming an optical information recording layer of this kind of optical recording medium, such as a sensitizer, an optical brightening agent, an ultraviolet ray absorbing agent, a thermal stabilizer, a chain transfer agent, an elasticizer, and a coloring agent.

A thickness of the optical information recording layer 3 is not less than 100 μm, preferably 100 μm to 2 mm, and more preferably 200 μm to 1.5 mm. If the thickness is less than 100 μm, it becomes difficult to perform a higher recording density and higher capacity of a three-dimensional recording such as a hologram memory.

As mentioned above, the optical information recording layer 23 is provided with a structure for hologram recording.

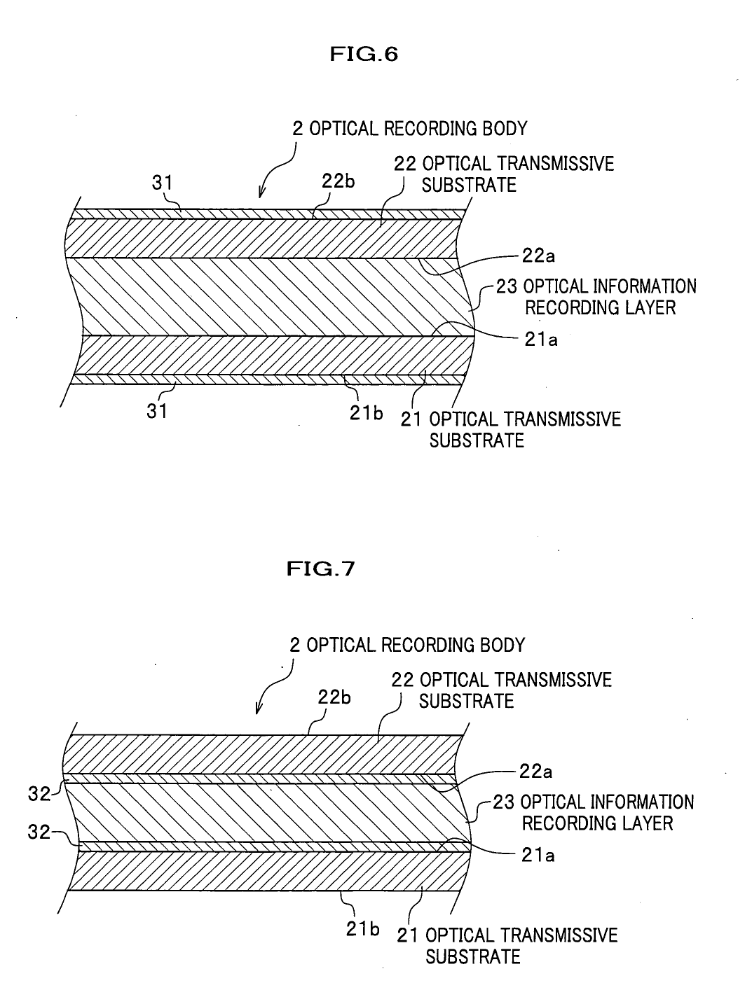

FIGS. 6 and 7 show other examples of the optical recording medium shown in FIG. 3. There may be provided, as shown in FIG. 6, light-shield layers 31 made of a material that does not absorb light (transmit) at wavelength regions for reading out the information in the optical information recording layer 23 and for a fixing process of the optical recording material at an outer surface 21b of the light transmissive substrate 21, and an outer surface 22b of the light transmissive substrate 22.

Similarly, there may be provided, as shown in FIG. 7, the light-shield layers 32 made of a material that does not absorb light (transmit) at wavelength regions for reading out the information in the optical information recording layer 23 and for a fixing process of the optical recording material at a surface 21a with which the light transmissive substrate 21 is contact and at a surface 22a with which the light transmissive substrate 22 is contact. This further improves a light-shielding characteristic with the light-shield cartridge 3 and provides preferable recording of the information with the recording light in the optical information recording layer 23, and preferable reading and reproducing of the information from the optical information recording layer 23.

As the light-shielding material forming the light-shielding is available, for example, a material in which dye or pigment is dispersed in the binder. The dye and the pigment have no absorption wavelength region at wavelength regions of the servo light and the fixing light, i.e., transmit the servo light and the fixing light. As the binder is available the component of the light recording material having described above, and as the dye is available the sensitizing dye for the light recording material.

The light-shield cartridge 3 comprises, as shown in FIG. 1, a housing provided by combining an upper half 4a with a lower half 4b. In the housing, an opening 5 is formed to introduce the recording light for recording the information in the optical recoding body 2 and light for reading the information, wherein the opening extends from a side surfaces of the upper half 4a and the lower half 4b toward the center of the housing. To the opening 5 is attached a shutter 6. The shutter 6 is always spring-loaded to close the opening 5 to prevent light to enter there except for recording and reading the information with, for example, a spring (not shown). The light-shield cartridge 3 has a drive mechanism (not shown) for rotating the optical recording body. During recording and reproducing the information, as shown in FIG. 2, the shutter 6 is opened to expose the opening 5 to allow the drive mechanism to enter there from the lower surface of the lower half 4b of the light-shield cartridge 3 to record and reproduce the information in the optical recording medium 2. Here, the opening 5 has such a structure that both the upper half 4a and the lower half 4b have openings.

The light-shield cartridge 3 is configured with a light-shielding material having transmittance of ultra-violet ray and visible light ray not greater than one percent. More favorably, a material having transmittance from 0.01% to 0.5% is used. More specifically, the shutter 6 at the upper half 4a and the lower half 4b are configured with a light-shielding material. Further, parts of the shutter 6 at the upper half 4a and the lower half 4b may be formed with the same light-shielding material or different light-shielding materials.

As the light-shielding material forming the light-shield cartridge 3 is available metal, plastic, and glass. If plastic or glass is used, to improve the light-shielding characteristic, dye or pigment may be contained.

As the dye can be used known organic ones such as a cyanine, phthalocyanine, naphthalocyanine, azo, anthraquinone, naphthoquinone, pyrylium, azulenium, squarylium, indophenol indoaniline, and triaryl methane. These dyes may be used independently in one kind or not less than two in combination.

As the pigment, for example, can be cited non-magnetic inorganic compounds such as metal oxides, metal carbonates, metal sulfates, metal nitrides, metal carbides, and metal sulfides; melamine resins; benzoguanamine resins; and the like. As concrete examples of the inorganic compounds can be cited α-aluminas with a ratio not less than 90%, β-aluminas, γ-aluminas, θ-aluminas, silicon carbides, chrome oxides, cerium oxides, α-iron oxides, hematite, goethite, corundum, silicon nitrides, titan oxides, silicon dioxides, tin oxides, magnesium oxides, tungsten oxides, zirconium oxides, boron nitrides, zinc oxides, calcium carbonates, calcium sulfates, barium sulfates, molybdenum disulfides, indium oxides, carbon black, ITO (tin oxide-indium oxide), and the like. These pigments can be used independently in one kind or not less than two in combination. These pigments may be subject to surface processing as needs.

The optical recording medium OM1, namely the cartridge, is preferably packaged with a light-shield package member 33 as shown in FIG. 8. This improves light-shielding property until the optical recording medium OM1 is used to record the information in the optical information recording layer 23 of the optical recording body 2. Further, the package member 33 protects light from entering the inside the light-shield cartridge 3 through peripheral portions of the light-shield cartridge 3 and a hub mounting portion. This further prevents unintentional problems such as damage of the light-shield cartridge 3 by falling and erroneously opening of the light-shield cartridge 3 by a user.

The light-shield package member 33 preferably has a sufficient light-shielding property, a sufficient sealing (air tight) property, a sufficient tear-resistivity, and a sufficient workability. The use of the light-shield package member 33 prevents the optical recording body 2 from absorbing humidity and is desirable in view of dust free.

As the light-shield package material forming the light-shield member, is available a base film or a base sheet coated with a light-shield layer containing a light-shielding material or a light-shielding material. As the base film or the base sheet, for example, are available a film or a sheet made of, for example, polyester resin, ionomer resin, cellulosic resin, urethane resin, epoxy resin, acrylic resin, polyamide resin (nylon 6, nylon 6.6, nylon 12), polypropylene resin, polyethylene resin, polyacrylonitrile resin, ethylene-alpha-olefin copolymer resin, propylene alpha-olefin copolymer resin, polystyrene resin, and polycarbonate resin. The base film or sheet may be an extended film or sheet, or a multilayer film or sheet including more than one layer. Further, they may be a sheet reinforced with a reinforced film or sheet. The film or sheet may be doped with plasticizer.

As the light-shielding material, is available metal foil such as aluminum foil, lead foil, iron foil, tin foil, zinc foil, electrolytic iron foil, copper foil, stainless alloy foil and carbon black or the like. When being formed, a light-shielding layer is coated with a light-shielding material on a surface of the base film or the sheet by a spray coating method, a vacuum evaporation method, a spattering method, an ion plating method, an electron-beam evaporation method. Furthermore, in addition to the light-shielding, a layer having a function for shielding water or humidity, oxygen, inert gases, and the air may be provided. Further, an antistatic layer may be provided.

As concrete examples, a package bag for photosensitive materials and its manufacturing method disclosed in Japanese laid-open patent publication No. 5-281664 are applicable to this light-shielding member and its manufacturing method.

Inside of the light-shield package member 33 is preferably filled with inert gas or air having humidity of not greater than 10% or in a vacuumed condition. As the inert gas, for example, He, Ne, Ar, N₂, or a mixture gas including two or more kinds of these gases.

Thus, the light-shield package member comprises a hermetical structure for hermetically enclosing the inert gas or the air inside the light-shield package member.

The optical recording medium OM1 in this embodiment shows an example in which the optical recording body 2 having a disk shape is housed in the light-shield cartridge 3. However, the optical recording medium according to the present invention is not limit to this, but applicable to those with various types such as a card type, a small-sized chip type, and a rectangular parallelepiped type. As an example, is provided an optical recording medium in which a card type of optical recording body is contained in a light-shielding cartridge 3 configured in accordance with the shape of the optical recording body and its use, wherein the optical recording body has a structure where the optical transmissive substrate 21, the optical information recording layer 23, and the optical transmissive substrate 22 are laminated in this order. This optical recording body 2 may be provided with a reflection layer between the light transmissive substrate 21 and the optical information recording layer 23 and/or with a protection layer, an oxygen shield layer, a humidity shield layer or the like between the optical information recording layer 23 and the light transmissive substrate 22.

A manufacturing method of the optical recording body 2 is not limited to this, and thus any method of manufacturing method of the optical recording body 2 may be used as long as the method provides the structure in which the optical information recording layer 23 is provided between two light transmissive substrates 21 and 22. For example, is provided a method including processes of: forming the optical information recording layer 23 by coating an optical recording material on one side surface of the light transmissive substrate 21; adhering another light transmissive substrate 22 on the optical recording layer; and forming a protection film on a side edge surface of the lamination body in which the optical recording layer 23 is sandwiched between two light transmissive substrates 21 and 22. Further, the optical recording body 2 with a predetermined configuration can be produced by shaping the light transmission substrates 21 and 22 in a predetermined shape, forming the optical information recording layer 23 on one side surface of the light transmissive substrates 21, and adhering the light transmissive substrate 22 thereto. Furthermore, the optical recording body with a predetermined configuration can be produced by forming the optical information recording layer 23 between the light transmissive substrates 21 and 22, the formed work is shaped in a predetermined shape by punching or cutting. The optical recording body 2 can be formed in a predetermined shape such as a disk (optical recording body 2), a card, or the like in accordance with its use.

As described above, the optical recording body 2 has been described as an example of the optical recording body 2 for holographic recording. However, the present invention is applicable to other three-dimensional optical recording body such as optical recording media in which one of various kinds of optical recording bodies such as an optical recording body using a multilayer optical memory and a multilayer optical memory using two-photon absorption is housed in light-shielding cartridge.

The process of forming the optical information recording layer 23 on the light transmissive substrate 1 can be performed by drying and forming the optical information recording layer 23 after coating or forming an embrocation containing an optical recording material with a predetermined thickness on the substrate 21. In addition, the process of forming the optical information recording layer 23 may also be performed by repeating the process of coating and drying the embrocation containing the optical recording material on the light transmissive substrate 1, and by forming a predetermined thickness of the optical information recording layer 23. In addition, in a case of not using a solvent for forming the optical information recording layer 23, the embrocation containing the optical recording material is coated or formed on the light transmissive substrate 21, and then the optical information recording layer 23 can be formed as it is without drying.

An embrocation containing an optical recording material can be adjusted by mixing the optical recording material and other components blended as needed, adding a solvent, and stirring them. It is preferable to adjust the embrocation under a darkroom lighting such as a red lamp in order to prevent the optical recording material from hardening.

As a solvent to be used, if it sufficiently dissolves an optical recording material used and gives a good film property, it is not specifically limited, and for example, followings can be cited: cello solve solvents such as a methylcello solve, ethylcello solve, methyl cellosolve acetate, and ethyl cellosolve acetate; propylene glycol solvents such as a propylene glycol mono methyl ether, propylene glycol mono ethyl ether, propylene glycol mono butyl ether, propylene glycol mono methyl ether acetate, propylene glycol mono ethyl ether acetate, propylene glycol mono butyl ether acetate, and dipropylene glycol dimethyl ether; ester solvents such as a butyl acetate, amyl acetate, ethyl acetate, butyl acetate, diethyl oxalate, ethyl pyruvate, ethyl-2-hydroxybutyrate, ethyl acetoacetate, methyl lactate, and methyl 3-methoxypropionate; alcohol solvents such as a butanol, heptanol, hexanol, diacetone alcohol, and furfuryl alcohol; ketone solvents such as a methyl isobutyl ketone, dimethyl ketone, cyclohexanone, methyl amyl ketone, and methyl ethyl ketone; high polarity solvents such as a dimethylformamide, dimethylacetoamide, N-methyl pyrrolidone; and mixed solvents of the above; and further cyanide hydrocarbons such as an acetonitrile; and something where aromatic hydrocarbons are added to the above. In addition, other than these can also be used halogen hydrocarbon solvents, for example, dichloromethane, trichloromethane, and the like. A ratio of solvents is usually within a range of around 10 to 90 folds by weight ratio for a total amount of the optical recording material. The solvents are preferably not more than 100 degrees Celsius in boiling point.

In addition, although a viscosity of an embrocation is appropriately adjusted in accordance with a coating method used, it is usually around 0.1 to 50 Ps. Particularly, if coating is performed with a coater knife such as a doctor knife, it is preferable that the viscosity is approximately from 1 to 30 Ps.

A coating method of an embrocation onto the light transmissive substrate 21 can be performed by a dip coat method, coater, rod, coil bar, extrusion coat, blade instrument, spin coat, and the like. Particularly, in order to obtain a uniform and thicker optical information recording layer, a coating method using the coil bar or the rod is preferable.

Furthermore, the optical recording medium according to the present invention can be produced by housing the optical recording medium with a predetermined light-shield cartridge 3. The light-shield cartridge 3 can be produced in a predetermined shape in accordance with the shape of the optical recording body to be housed and the use of the optical recording body or the like.

When the optical recording medium is enclosed in the light-shield package, an opening of the light-shield package member 33 is closed by adhesion with adhesive or heat sealing or the like (the hermetical structure) to hermetically enclose the optical recording medium in the light-shield package member 33. In this operation, the light-shied package member 33 may be sealed with filling with the inert gas or the air containing humidity of not greater than 10% as needs. Alternatively, the light-shied package member 33 may be sealed in which the air inside the light-shielding package member 33 is vacuumed to provide a vacuum or a substantially vacuumed condition within the light-shield package member 33.

### EXAMPLE

Here will be concretely described the present invention according to examples of the invention and comparison examples.

### Example 1

<<Adjustment of Embrocation A>>

A binder, a monomer, polymerization inhibitors (contained in the monomer), a sensitizing dye, and a polymerization initiator were checkweighed under a red lamp, were put in a brown eggplant-shape flask, dichloromethane was further put in as a solvent, they were stirred for three hours, using a stirrer, and thus an embrocation A containing prescribed optical recording materials shown in Table 1 below was obtained. A viscosity of the embrocation A was 21 Ps.

TABLE 1

| | Material | Mass Ratio |
|---|---|---|
| Binder | CAB531-1 | 1000 |
| Monomer | POEA | 920 |
| Polymerisation | MEHQ | 0.276 |
| Inhibitor | | |
| Sensitizing Dye | DEAW | 0.56 |
| Polymerisation | MBO | 36 |
| Initiator | o-CL-HABI | 24 |
| Solvent | Dichloromethane | 6240 |

NB:

CAB531-1, Cellulose-Acetate-Butylate (manufactured by Eastman Chemical Co.);

POEA, Acrylic Acid 2-Phenoxyetyl (Cas No. 48145-04-6);

MEHQ, 4-Methoxyphenol (Cas No. 150-76-5);

DEAW, Cyclopentanone-2,5-bis((4-(Diethyl Amino)Phenyl)Methylene) (Cas No. 38394-53-5);

MBO, 2-Melcaptobenzoxazole (Cas No. 2382-96-9); and o-CL-HABI, 2,2-bis(o-Chlorophenyl)-4,4,5,5-Tetoraphenyl-1,1-Biimidazole (Cas No. 1707-68-2).

The embrocation A was coated on a transparent substrate (polycarbonate, thickness 80 μm) with using a coater of a clearance of 300 μm (gap length), and was dried for three minutes at 40 degrees Celsius. Furthermore, subsequently, a process of coating and drying the embrocation A was repeated twice, and thus an optical information recording layer of a total thickness of 120 μm was formed on the transparent substrate. Then an optical recording lamination body was obtained. Then, a glass substrate (thickness, 1 mm) was laminated on the optical information recording layer.

<Light-Shield Cartridge>

The light-shield cartridge 3 having the structure shown in FIGS. 1 and 2 was formed with polycarbonate containing carbon black of 30 mass %. Light transmittance, from the inside to the outside, of the obtained light-shield cartridge 3 was measured. All the light transmittance at 300 nm, 400 nm, 500 nm, 600 nm, and 700 nm is not greater than one percent.

Next, a dichloromethane solution containing the binder (CAB531-1) of 20 mass % was adjusted, and using a brush, the solution was coated at edges of the transparent substrate, the optical information recording layer, and the glass substrate; then a coating treatment thereof was performed, and a sample of an optical recording medium was made.

The optical recording medium having the structure shown in FIG. 1 was produced where the optical recording body produced as mentioned above is housed.

<Light-Shield Package Bag>

Further, the light-shield package bag was formed with polyethylene sheet of which surface had been aluminum-laminated, and the optical recording medium is enclosed with the light-shield package bag to seal the opening of the light-shield package bag by thermo-compression bonding to eliminate the opening.

### Example 2

<<Adjustment of Embrocation B>>

A binder, a dye decolored by acid, an acid generation agent, and a sensitizing dye were checkweighed under a red lamp, were put in a brown eggplant-shape flask, a solvent further was put in, they were stirred for three hours, using a stirrer, and thus an embrocation B containing prescribed optical recording materials shown in Table 2 below was obtained.

TABLE 2

| | Material | Mass Ratio |
|---|---|---|
| Binder | PMMA | 1000 |
| Dye decolored | Dye A | 80 |
| by acid | | |
| Acid | Acid | 500 |
| Generation | Generation | |
| Agent | Agent A | |
| Sensitizing Dye | Dye B | 80 |
| Solvent | Methylene Chloride | 3250 |
| Solvent | Acetonitrile | 1052.5 |

NB:

PMMA, Polymethylmethacrylate (manufactured by Aldrich Inc. Mw: 996000);

Dye A, a quaternary ammonium salt expressed in a formula (a) below; Acid Generation Agent A, Diphenyliodonium-Hexafluorophosphate (Cas No. 58109-40-3); and

Dye B, Ru complex compound expressed in a formula (b) below.

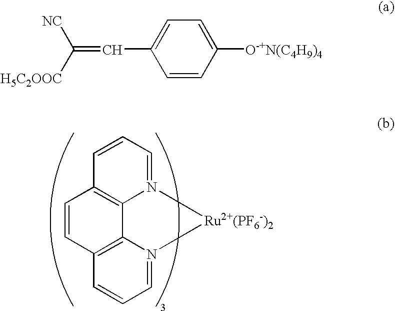

A sample of the optical recording body was produced as similar to the first embodiment except that the embrocation B is used instead of the embrocation A.

In the optical information recording layer formed by the embrocation B the sensitizing dye A is excited at a light portion of an interference pattern, and electrons are emitted from the excited dye A. The emitted electrons move to the acid generation agent, and an acid is generated by the acid generation agent. By the acid the dye B (dye decolored by acid) different from the sensitizing dye A is decolored, and thereby a refractivity of the optical information recording layer changes. Thus, by decoloring the dye B at the light portion of the interference pattern, a refractivity modulation occurs and a hologram is recorded.

<Evaluation>

The optical recording mediums obtained in the first and second embodiments were stored in an ambient atmosphere including 40 RH % at 25 C under fluorescent lamp lightening for one week. Diffraction indexes before and after storage were measured by the following method. In addition, for comparison, the diffraction efficiencies of the optical recording members produced in the first and second embodiments produced as comparison 1 and comparison 2, respectively, were measured in the same condition without enclosing them in the light-shield cartridge before and after the storage. In addition, a thickness of the optical information recording layer is measured and shown in table (3).

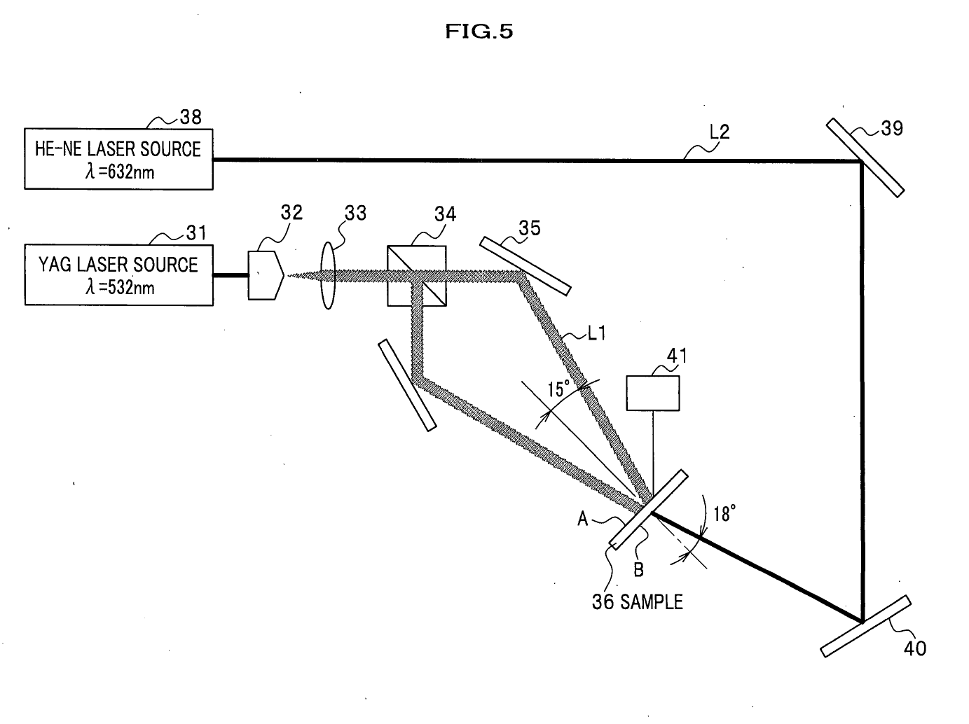

As shown in FIG. 5, was performed a recording on an obverse A of an optical recording medium 36 (sample) at an incident angle of 15 degrees, with a spot diameter of 8 mm, a power output of 3 mW per beam, and a recording energy of 2000 mJ/cm², using a wavelength of 532 nm of a YAG laser light L1 radiated on the obverse A of the medium 36 from a YAG laser source 31 through an object lens 32, a lens 33, a beam slitter 34, and a mirror 35.

Next was radiated a wavelength of 633 nm of a He—Ne laser light L2 on a reverse B of the optical recording medium 36 at an incident angle of 18 degrees from a He—Ne laser source 38 through mirrors 39 and 40, and was observed a change of a diffraction efficiency for an exposure amount. At this time, the diffraction efficiency was obtained according to a below formula from a diffraction light amount of the He—Ne laser measured by a power meter 41 provided at a side of the obverse A of the optical recording medium 36 and an incident light amount (outgoing light amount from the He—Ne laser source 38) of the He—Ne laser entering the reverse B of the medium 36:
Diffraction efficiency (%)=intensity of diffraction light/intensity of incident light×100.
<<Thickness of Optical Information Recording Layer>>

Each total thickness of the optical information recording layers was measured, using DIGITAL MICROMETER manufactured by SONY CO.

TABLE 3

| | | | Comparison | Comparison |
|---|---|---|---|---|
| | Example 1 | Example 2 | Example 1 | Example 2 |
| Embrocation | B | B | A | B |
| Light | PC | PC | PC | PC |
| Transmissive | | | | |
| Substrate | | | | |
| Light-Shield | With | With | Without | Without |
| Cartridge | | | | |
| Light-Shield | With | Without | Without | Without |
| Package Bag | | | | |
| Thickness of | 120 | 121 | 120 | 122 |
| Optical | | | | |
| Recording | | | | |
| Material | | | | |
| Layer [μm] | | | | |
| Diffraction | 32 | 32 | 30 | 32 |
| Efficiency [%] | | | | |
| before storage | | | | |
| Diffraction | 30 | 28 | 1 | 1.5 |
| Efficiency [%] | | | | |
| after storage | | | | |

As shown in Table (3), the optical recording medium of the first embodiment shows almost the same values of diffraction efficiency as that before the storage. Further, the optical recording medium of the second embodiment shows the diffraction efficiency of 28%, which decrease from that of 32% before storage. However, this change is in a level of no problem. Next, in the comparison 1, the diffraction efficiency decreased to 1% after the storage. Further, in the comparison 2, the diffraction efficiency decreased to 1.5% after the storage.

As mentioned above, the cartridge 3 comprises a light-shield material including a transmittance of not greater than one percent at range over ultraviolet and visible light for enclosing the optical body 2 to improve light-shielding property until information is recorded in the optical recording medium OM1 to provide a stable record of the optical information.

In the optical recording medium according to the present invention the light-shielding property is improved until the information is recorded therein. This prevents the optical recording medium from being exposed to unexpected invading light (leaked light) until the information is recorded in the optical recording medium by irradiating the recording light. Particularly, the above-mentioned configuration prevents light from invading the inside of the light-shield cartridge 3 through a peripheral of the hub of the disk. Accordingly, the optical recording medium can stably record the optical information. Furthermore, packaging of the light-shield cartridge 3 with light-shield package member 33 further improves the light-shielding property.

The invention claimed is:

1. An optical recording medium comprising:
a body comprising:
two light transmissive substrates each including a thickness not less than 50 μm; and
an optical information recording layer including a thickness not less than 100 μm between said two light transmissive substrates, the optical information recording layer including an optical recording material, wherein information is recorded in physical change of the optical recording material by recording light; and
a cartridge comprising a light-shielding material including a transmittance of not greater than one percent at a range of ultraviolet and visible light for enclosing the body.

2. The optical recording medium as claimed in claim 1, wherein the two light transmissive substrates transmit the recording light, reading light for reading servo control data to be recorded in the optical information recording layer and fixing light for fixing the physical change in the optical recording material.

3. The optical recording medium as claimed in claim 1, further comprising, between each light transmissive substrate and the optical information recording layer, light-shielding layers that transmit the recording light, reading light for reading servo control data to be recorded in the optical information recording layer, and fixing light for fixing the physical change in the optical recording material.

4. The optical recording medium as claimed in claim 1, further comprising at outer surfaces of the light transmissive substrate light-shielding layers that transmit the recording light, reading light for reading servo control data to be recorded in the optical information recording layer and fixing light for fixing the optical recording material.

5. The optical recording medium as claimed in claim 1, wherein the two light transmissive substrates each comprise a film comprising at least one kind of organic resin selected from a group consisting of polycarbonate, triacetylcellulose, cycloolefin polymer, polyethylene terephthalate, polyphenylene sulfide, acrylic resin, methacrylic resin, polystyrene resin, vinyl chloride resin, epoxy resin, polyester resin, and amorphous polyolefin.

6. The optical recording medium as claimed in claim 5, wherein the two light transmissive substrates comprise polycarbonate.

7. The optical recording medium as claimed in claim 1, further comprising a light-shield package member for enclosing the cartridge.

8. The optical recording medium as claimed in claim 7, further comprising an inert gas, wherein the light-shield package member comprises a hermetical structure for hermetically enclosing the inert gas inside the light-shield package member.

9. The optical recording medium as claimed in claim 7, further comprising air including humidity not greater than 10%, wherein the light-shield package member comprises a hermetical structure for hermetically enclosing the air inside the light-shield package member.

10. The optical recording medium as claimed in claim 7, wherein the light-shield package member comprises a hermetical structure for hermetically enclosing the optical recording medium inside the light-shield package member, and inside of the light-shield package is vacuumed.

11. The optical recording medium as claimed in claim 7, wherein the light-shield package member comprises a base film including a light-shielding layer comprising a light-shielding material.

12. The optical recording medium as claimed in claim 1, wherein the thickness of the optical information recording layer is from 100 μm to 2 mm.

13. The optical recording medium as claimed in claim 1, wherein the thickness of the optical information recording layer is from 100 μm to 1.5 mm.

14. The optical recording medium as claimed in claim 1, wherein one of the two light transmissive substrates, which is opposite to the other of light transmissive substrate exposed to the recording light, comprising a recording surface contacting the optical information recording layer, the recording surface comprising a region for recording a servo signal.

15. The optical recording medium as claimed in claim 1, wherein the information recording layer comprises a structure for hologram recording.

16. The optical recording medium as claimed in claim 15, wherein the optical recording material shows at least one kind of characteristic change selected from a group consisting of a refractive index, a transmittance, a permittivity, a reflectivity, and an absorption index change along highlight and shadow in an interference pattern formed in the optical information recording layer when the optical information recording layer is exposed to the recording light.

17. The optical recording medium as claimed in claim 16, wherein the optical recording medium comprises an optical recording composition comprising a binder, dye causing refractive index modulation, a photoreactive substance for coloring and decoloring the dye, and sensitizing dye for developing the photoreactive substance.

18. The optical recording medium as claimed in claim 15, wherein the optical recording material comprising a photopolymer material including a binder, a polymerization monomer, a sensitizing dye, and a polymerization initiator.

19. The optical recording medium as claimed in claim 16, wherein the optical recording medium comprises an optical recording composition comprising a binder, dye causing refractive index modulation, a photoreactive substance for coloring and decoloring the dye, sensitizing dye for developing the photoreactive substance, polymerizing monomer, and polymerization initiator.

20. The optical recording medium as claimed in claim 1, wherein the optical information recording medium comprises a multilayer optical memory using two-photon absorption.
